(19) United States
(12) Patent Application Publication
(10) Pub. No.: US 2015/0233347 A1
(43) Pub. Date: Aug. 20, 2015

(54) BLADE ROTATION ANGLE REGULATING AND BRAKING DEVICE FOR LARGE VERTICAL AXIS WIND TURBINE

(71) Applicant: Qiang YAN, Shanghai (CN)

(72) Inventor: Qiang YAN, Shanghai (CN)

(21) Appl. No.: 14/228,180

(22) Filed: Mar. 27, 2014

(30) Foreign Application Priority Data
Feb. 19, 2014 (CN) 201410056111.4

(51) Int. Cl. F03D 3/06

(52) U.S. Cl. CPC F03D 3/068

(57) ABSTRACT

Vertical axis wind turbine and a blade rotation angle regulating and braking device for the turbine, with one end of the radial arms of the turbine being connected with the main shaft, and a blade rotation angle regulator and braking device is deployed at the other end of the radial arms. The blade rotation angle regulating and braking device comprising a base, a blade arm, a pivot shaft, a blade rotation angle driving device, and a blade braking device. The blade is connected to the radial arm through the blade arm, the length axis of the blade is parallel to the main shaft. The present invention meets the demands for driving the blade to rotate in lower wind speeds, fixing the blade angle in higher wind speeds, and making the wind rotor more efficient.

### CROSS-REFERENCE AND RELATED APPLICATION

The subject application claims priority on Chinese patent application No. CN 201410056111.4 filed on Feb. 19, 2014. The contents and subject matter of the Chinese priority application is incorporated herein by reference.

### FIELD OF THE INVENTION

The present invention relates to the vertical axis wind turbine, and particularly to a blade rotation angle regulating and braking device for a large vertical axis wind turbine.

### BACKGROUND OF THE INVENTION

Currently, the blade setting angle of the vertical axis wind turbines (VAWTs) is usually fixed, and for such fixed blade setting angle of the VAWTs, when the wind rotor rotates, the magnitude of torque and direction of forces on the blade are changing all the time based on the blade's position on the wind rotor rotation orbit. At certain positions, the torque is bigger and at other positions smaller; at certain positions, the torque is positive and at other positions negative. For large VAWTs, the diameter of the wind rotor is increased and the rotation speed of wind rotor is lowered, the torque changes on the blade become more significant. Therefore, the wind rotor of the large VAWTs usually has lower aerodynamic efficiency as the ultimate torque output of the wind rotor is the resultant torque on all the blades.

To overcome the defects of lower torque output of VAWTs with fixed blade setting angle, Chinese patent applications CN200610023892.2 and CN200610027384.1 disclose the specific rotation angle range and method to realize blade rotation. The centrifugal force on the blade increases with the square of the wind rotor rotational speed. When the wind rotor rotates, there is aerodynamic torque on the blade caused by the wind, apart from the centrifugal force, with the torque may be positive or negative based on the blade's orbit position, and the resultant torque differs greatly. A large VAWT has to meet the demands of overcoming resultant aerodynamic torque and centrifugal torque in both lower wind speeds and higher wind speeds. Therefore, it takes a high output driving device to regulating the rotation angle of one single blade. In fact, the wind rotor usually has a number of blades, e.g., 3, 4, 5, or more. Therefore, the driving devices would be of high output, large, and costly, thus impractical and difficult to be applied commercially.

Taken for example, a 50 kW VAWT with a 12meter diameter wind rotor, 2 meter width, 9 meter height, and 320 kg weight blade: when the wind speed is 2 m/s and rotation speed of the wind rotor is 6.5 r/m, the centrifugal force on each blade is 890 N; when the wind speed is 6 m/s and rotation speed of wind rotor is 19 r/m, the centrifugal force on each blade is 7600 N; and when the wind speed is 13 m/s and rotation speed of wind rotor is 40 r/m, the centrifugal force reaches a staggering 33700 N on each blade.

### SUMMARY OF THE INVENTION

The object of the present invention is to overcome the problem of the inability of the current technology to regulate the blade rotation angle of large VAWTs and the difficulty for their practical application. The present invention provides a driving and braking device that meets the demand for rotating the blade in lower wind speeds and maintaining certain fixed angles in higher wind speeds, so as to ensure higher efficiency and realize industrialization and commercialization for large VAWTs.

The present invention provides a blade rotation angle regulating and braking device for a large vertical axis wind turbine. The large vertical axis wind turbine has blades with each blade having a leading edge and a tailing edge; radial arms with each radial arm having a first end and a second end and corresponding to the blade and for connecting the blades; and a main shaft. The first end of the radial arm is connected to the main shaft. The blade rotation angle regulating and braking device is deployed at the second end of the radial arm. The blade rotation angle regulating and braking device comprises a base, a blade arm, a pivot shaft, a blade rotation angle driving device, and a blade braking device. The blade is connected to the corresponding radial arm through the blade arm, and the length axis of the blade is parallel to the main shaft. “Length axis” means the straight line between both ends of a blade.

Further, the blade arm is deployed horizontally.

Further, the intersection point of the blade arm and the mean camber line is set at ⅓ to ½ from the leading edge of the blade, between the leading edge and the tailing edge of the blade.

Further, the blade arm has a first end and a second end. The first end of the blade arm is connected with the blade, and the second end of the blade is of a fan-shape, acting as a brake disc, and is rotatable around the pivot shaft.

Further, the blade braking device comprises a caliper that is deployed on the fan-shaped end of the blade arm to brake the blade.

Further, the brake disc is horizontally or vertically deployed.

Further, the blade rotation angle driving device includes a servo motor with a gearbox.

Further, the blade rotation angle driving device includes a hydraulic swing motor with or without a gearbox.

Further, the pivot shaft is vertically deployed, supported by a plurality of bearings, and the lower bearing is an angular contact bearing.

Further, the leading edge of the blade is balance weighed to make the intersection point of blade arm and mean camber line close to or even to meet the center of gravity of the blade.

The present invention also provides a method for braking the blade. The decision on whether to apply the blade brake is based on the wind speed input. If the decision is yes, then, a further decision on whether to conduct feathering is necessary. If the decision is yes to feathering, the feathering will be conducted for the blade, otherwise the blade will be braked. If applying the blade brake is not necessary, the blade will rotate accordingly based on wind conditions. A further decide on whether to apply over speed regulation is necessary. If the decision is yes for over speed regulation, then, a further decision on whether to have feathering is necessary. If the decision is no for over speed regulation, it will go back to the situation that the blade will rotate accordingly based on wind conditions.

### BRIEF DESCRIPTION OF THE DRAWINGS

FIG. 1 shows the general structure of the VAWT.

FIG. 2 shows the partial enlarged view of the VAWT;

FIG. 3 shows the blade rotation angle regulating and braking device for the large vertical axis wind turbine of the present invention;

FIG. 4 shows the second embodiment of the structure of the blade rotation angle regulating and braking device for the large vertical axis wind turbine of the present invention;

FIG. 5 shows the structure of the upper bearing and the lower bearing;

FIG. 6 shows the third embodiment of the structure of the blade rotation angle regulating and braking device for large vertical axis wind turbine of the present invention;

FIG. 7 shows the fourth embodiment of the structure of the blade rotation angle regulating and braking device for the large vertical axis wind turbine of the present invention;

FIG. 8 shows the structure of the flange used in the present invention;

FIG. 9 shows the selection of the intersection point of the blade arm and mean camber line (c.g.=center of gravity);

FIG. 10 is a flow chart showing the method for controlling the blade braking; and

FIG. 11 shows the aerodynamic torque outputs at 13 m/s wind speed for the different selection of intersection points of the blade arm and mean camber line.

Reference numbers are:

| | | |
|---|---|---|
| 1. radial arm; | 2. blade; | 3. pitch transmission |
| | | device; |
| 4. generator; | 5. cabin cover; | 6. truss tower; |
| 7. hydraulic pressure clamp; | 8. brake wheel; | 9. collecting ring; |
| 10. encoder; | 11. maintenance | |
| | platform; | |
| 12. wind detection device; | 13. pump station; | 14. caliper; |
| 15. blade arm; | 16. base; | 17. pivot shaft; |
| 18. gearbox; | 19. servo motor; | 20. upper bearing; |
| 21. lower bearing; | 22. brake disc; | 23. bearing base; |
| 24. hydraulic tank; | 25. flange; | 26. main shaft; |
| 27. leading edge; | 28. tailing edge. | |

### DETAILED DESCRIPTION OF THE EMBODIMENTS

The embodiments of the present invention are further illustrated in the following examples. The examples do not limit the scope of the present invention, as one of skilled in the art may modify the examples without departing from the scope of the present invention.

### Example 1

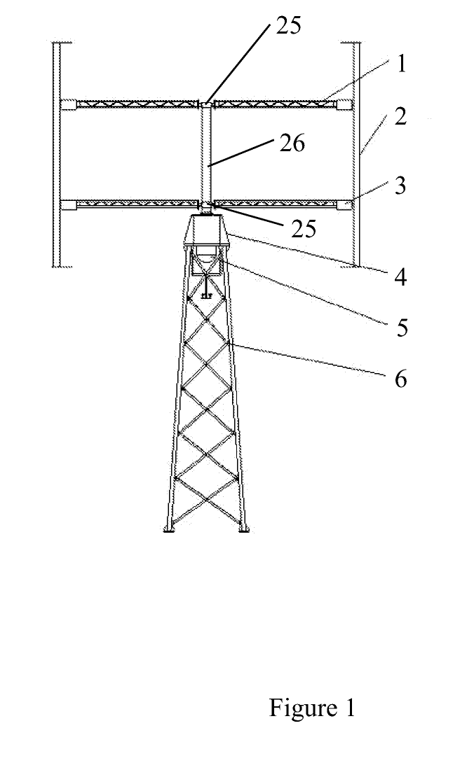

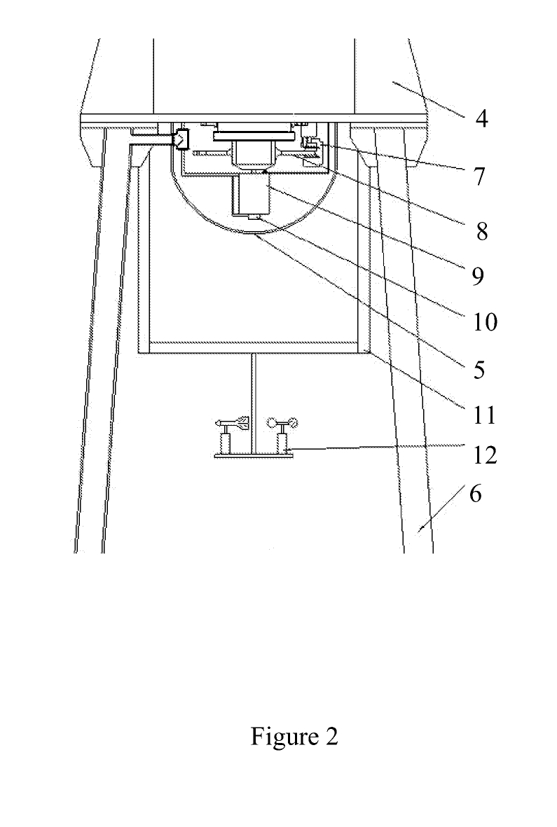

The imaginary straight line between the leading and trailing edges is called “chord. ” The angle formed by chord and the tangent line to the wind rotor rotation orbit is called “rotation angle. ” The position of a blade in the wind rotor rotation orbit is defined as “azimuth. ” The present invention discloses a device to make the blade rotate. FIG. 1 shows the general structure of the VAWT, and FIG. 2 is the partial enlargement view of the VAWT. The generator 4 is placed on the top of a truss tower 6, and a brake wheel for the main shaft 8, a hydraulic braking unit which is a hydraulic pressure clamp 7, a collecting ring 9, and an encoder 10 are orderly arranged underneath the generator 4 and covered by the cabin cover 5 as shown in FIGS. 1 and 2. The main shaft 26 is connected with the blade 2 through the upper or lower flanges 25, truss radial arms 1, and the blade 2 is rotatable around the pivot shaft 17.

While the wind rotor is rotating, apart from the gravity, the blades experience two forces, i.e., the centrifugal force caused by the rotation of wind rotor, and the torque around the axis of blade caused by the wind, which is also called “aerodynamic torque. ” Aerodynamic torque changes significant according to the position of a blade in the rotation orbit, and when the wind speed changes, the aerodynamic torque also changes significant on a blade even at the same point of the orbit. For example, when the wind speed increases from cut-in wind speed (e.g. 2 m/s) to rated speed (e.g. 13 m/s) or even cut-out speed (e.g. 25 m/s or higher), the aerodynamic toque on the blade increased by dozens of times. Therefore, the output of the driving device has to be very big in order to rotate the blade in real time under various wind speeds.

In the present invention, the blade rotation condition is divided in lower wind speed condition and higher wind speed condition. The blade rotates while the wind rotor rotates in lower wind speed condition, and the blade is braked by hydraulic unit in higher wind speed condition (e.g., 10 m/s), and the blade remains at a preset angle.

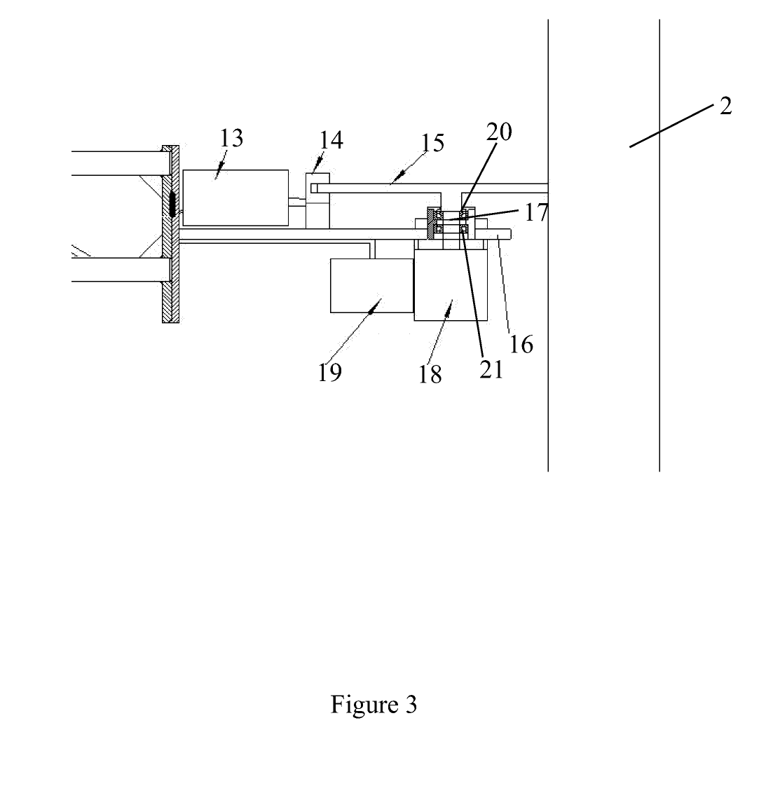

FIG. 3 shows the blade rotation angle regulating and braking device for the large vertical axis wind turbine of the present invention, which can be referred to as “pitch transmission device” 3 as well. One end of the radial arm 1 is connected to the main shaft 26 through a flange 25, and the other end of the radial arm 1 is connected with the base 16. The structure of the flange 25 is shown in FIG. 8. The blade arm 15 is set horizontally, and is connected with the pivot shaft 17. One end of the blade arm 15 is fixed to be connected with the blade 2, and the other end is made in a fan shape, acting as a brake disc for braking the blade. A caliper 14 is deployed at the fan-shaped end of the blade arm 15, braking the blade 2, fixing the blade rotation angle when certain wind speed is reached. As shown in FIG. 5, there is an upper bearing 20 and a lower bearing 21 around the pivot shaft 17. Both the upper bearing 20 and the lower bearing 21 are provided with a bearing base 23; the lower bearing 21 is of the angular contact type in order to better bear weight. As shown in FIGS. 3 and 5, the pivot shaft 17 goes through the base 16 and connected with the shaft of the gearbox 18, which is driven by a servo motor 19 or a hydraulic motor.

### Example 2

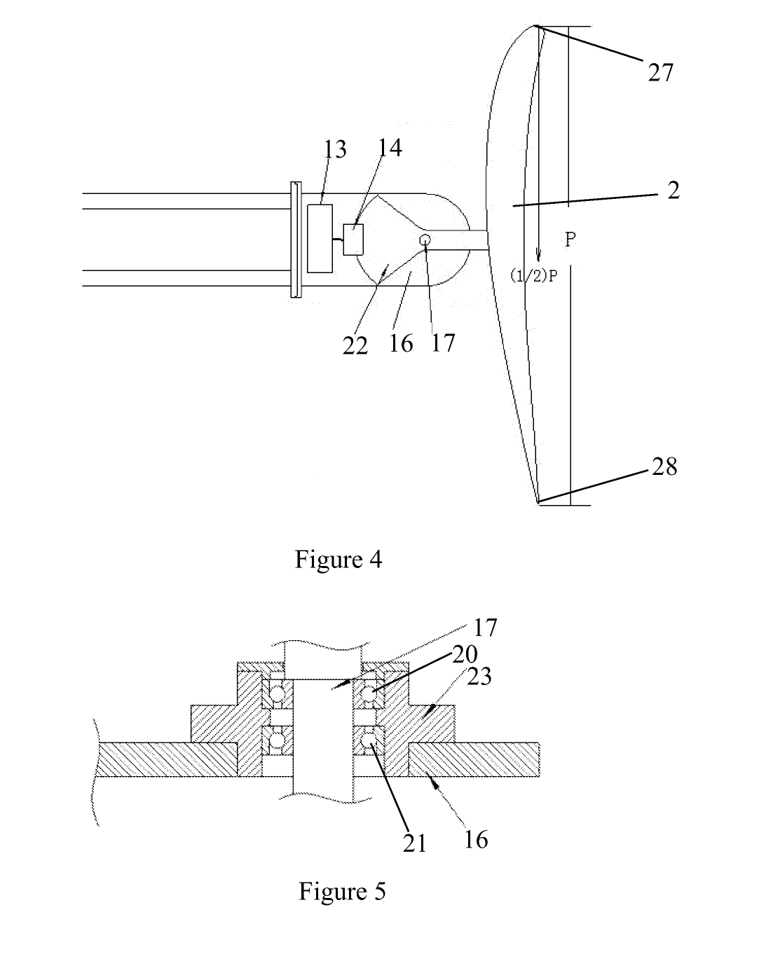

FIG. 4 shows the second embodiment of the structure of blade rotation angle regulating and braking device for the large vertical axis wind turbine of the present invention, where the pivot shaft 17 goes through the base 16 and is connected with a transmission device (or a gearbox). A brake disc 22 is connected with the pivot rotation shaft 17 for the purpose of fixing the blade rotation angle. Alternatively, the brake disc 22 may be deployed at the connecting part of transmission and the gearbox 18 as well.

### Example 3

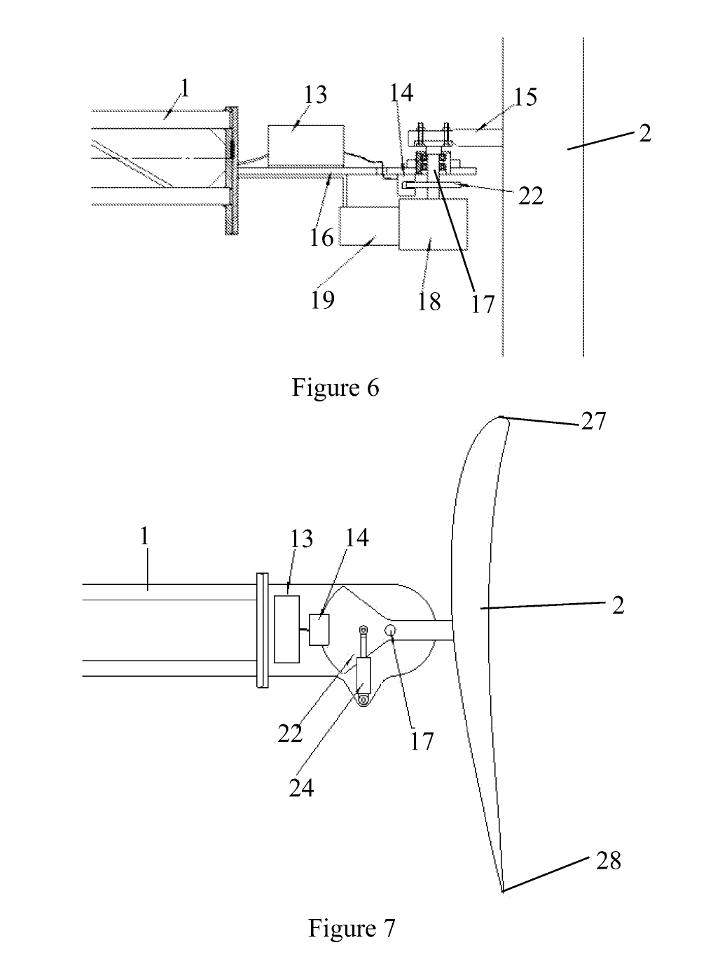

FIG. 6 shows the third embodiment of the structure of the blade rotation angle regulating and braking device for the large vertical axis wind turbine of the present invention, where the brake disc 22 is placed under the base 16.

### Example 4

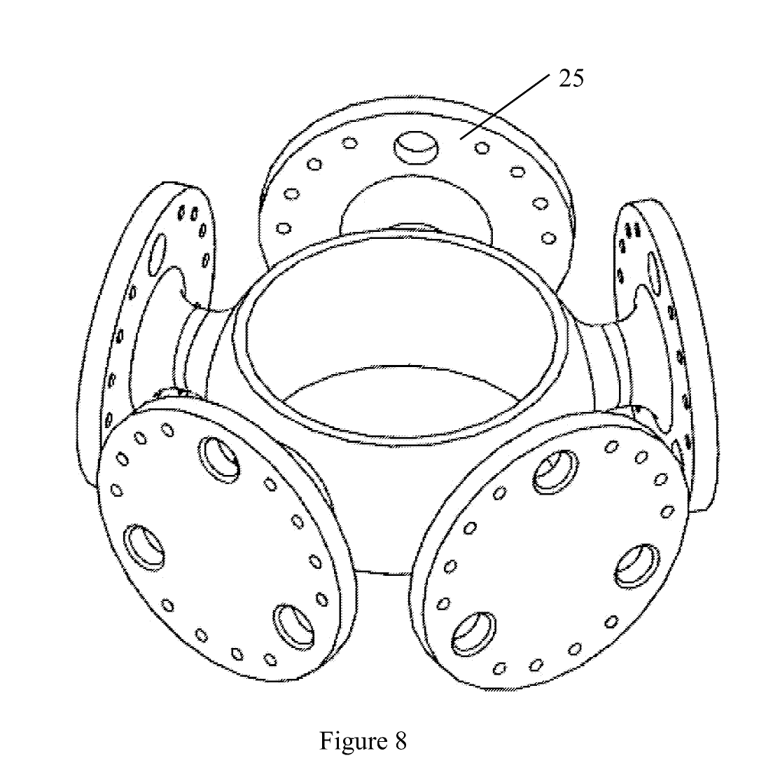

FIG. 7 shows the fourth embodiment of the structure of the blade rotation angle regulating and braking device for the large vertical axis wind turbine of the present invention, where the blade rotation driving device is a hydraulic thruster 24.

### Example 5

Taken for example, a large VAWT with a 12-meter diameter wind rotor, 2-meter wide, 9-meter tall and 320-kg heavy blades: when the wind speed is 2 m/s and rotation speed of wind rotor is 6.5 r/m, the centrifugal force produced is 890 N on each blade; when the wind speed is 6 m/s and rotation speed of wind rotor is 19 r/m, the centrifugal force produced is 7600N on each blade; and when the wind speed is 13 m/s and rotation speed of wind rotor is 40 r/m, the centrifugal force reaches a staggering 33700 N on each blade. The following table shows the torque caused by centrifugal and aerodynamic torque while the blade arm intersects with different points on the mean camber line under wind speeds of 13 m/s and 25 m/s respectively. The maximum difference is 15800 N m. To make the center of gravity close to the intersection point of blade arm and mean camber line, a balance weight may be deployed in the leading edge.

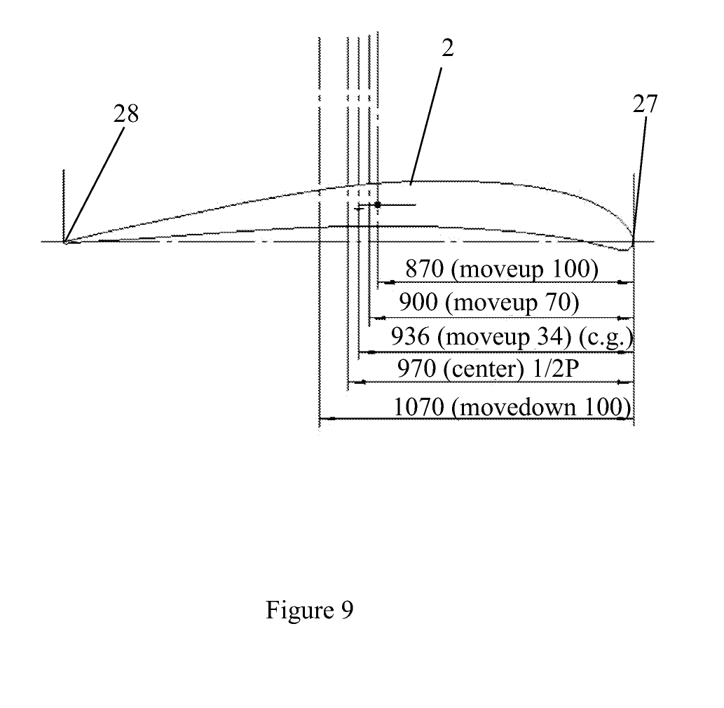

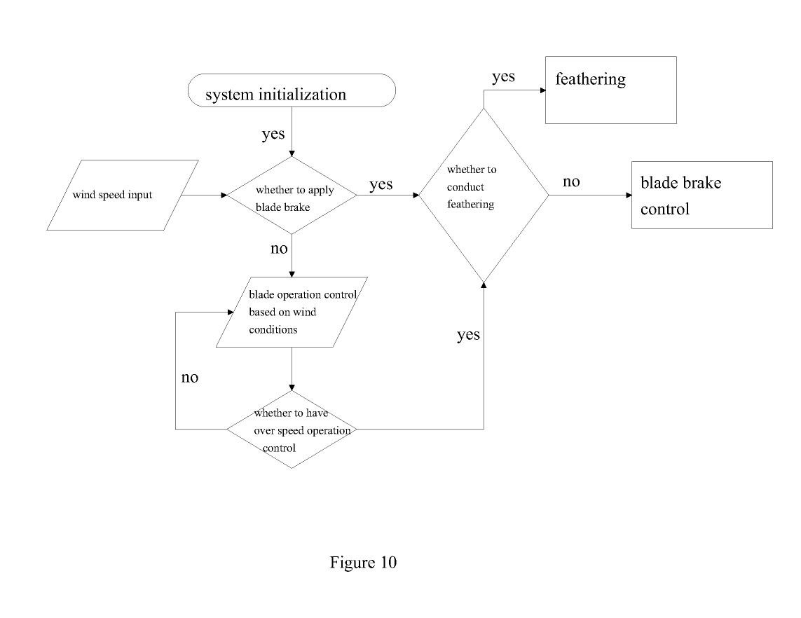

As shown in FIG. 9, the intersection point of blade arm and mean camber line is set at ⅓ to ½ from the leading edge of the blade 2, between the leading edge 27 and the tailing edge 28.

The following table shows the torque produced when the blade arm 15 intersects with different points on the mean camber line under a wind speed of 13 m/s:

| | | | |
|---|---|---|---|
| | Distance to | | |
| | leading | Distance to | Distance to |
| | edge: 870 | leading edge: 900 | leading edge: 935 |
| Position of the | Center | Center | Center |
| Blade Arm (mm) | forward: 100 | forward: 70 | forward: 34.4 |

Wind Speed 13 m/s, rotation speed of wind rotor 40 rpm, rotation angle
of blade −8° to 8°

| | | | |
|---|---|---|---|
| centrifugal force | 33700 | 33700 | 33700 |
| on the blade (N) | | | |
| maximum torque | 3390 | 2440 | 1300 |
| N by the | | | |
| centrifugal force | | | |

Wind Speed 13 m/s, rotation speed of wind rotor 40 rpm, rotation angle
of blade −4° to 4°

| | | | |
|---|---|---|---|
| centrifugal force | 33700 | 33700 | 33700 |
| on the blade (N) | | | |
| maximum torque | 2750 | 1790 | 655 |
| N by the | | | |
| centrifugal force | | | |

Wind Speed 25 m/s, rotation speed of wind rotor 48 rpm, rotation angle
of blade −4°

| | | | |
|---|---|---|---|
| centrifugal force | 48460 | 48460 | 48460 |
| on the blade (N) | | | |
| maximum torque | 2074 | 680 | −940 |
| N by the | | | |
| centrifugal force | | | |

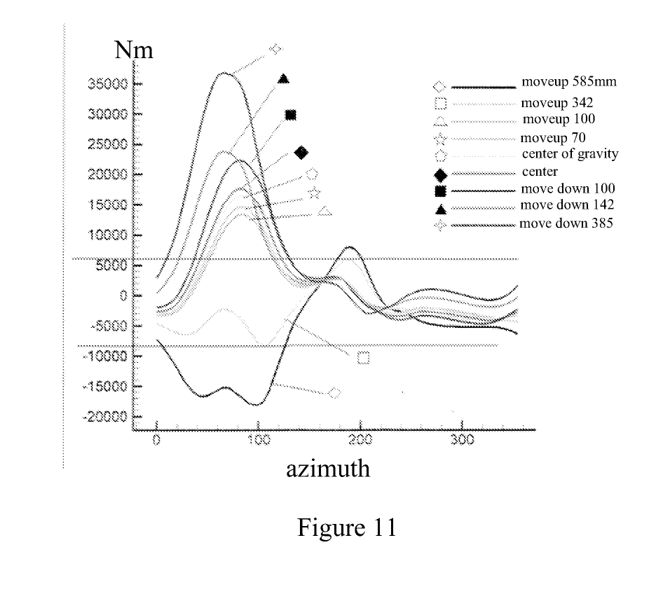

FIG. 11 shows the torque produced when the blade arm intersects with different points on the mean camber line under a wind speed of 13 m/s.

If the wind speed increases to 30 m/s, the resultant torque will be several times of that under a wind speed of 13 m/s, and dozens times of that under a wind speed of 6 m/s. If the rotation speed of the wind rotor is 40 rpm, the wind rotor covers 10 degrees within 0.04 second, and to drive the blade to rotate within such a short period, the driving force has to be very big. Therefore, the driving device has to have an extremely big output, and such device is big and costly, making industrialization and commercialization very difficult. However, if the blade brake is applied when the wind speed exceeds 6 m/s, the resultant torque is only a fraction of the resultant torque under the wind speed of 25 m/s. Therefore, the volume and cost of the driving device can be cut significantly, making the device ready for industrialization and commercialization.

The flow chart for the blade braking control method is shown in FIG. 10. As shown in FIG. 10, the decision on whether to apply the blade brake is based on the wind speed input. If the decision is yes, then, a further decision on whether to conduct feathering is necessary. If the decision is yes to feathering, the feathering will be conducted for the blade, otherwise the blade will be braked. If applying the blade brake is not necessary, the blade will rotate accordingly based on wind conditions. A further decide on whether to apply over speed regulation is necessary. If the decision is yes for over speed regulation, then, a further decision on whether to have feathering is necessary. If the decision is no for over speed regulation, it will go back to the situation that the blade will rotate accordingly based on wind conditions.

I claim:

1. A device for regulating and braking a blade rotation angle for a large vertical axis wind turbine having blades with each blade having a leading edge and a tailing edge; radial arms with each radial arm having a first end and a second end and each radial arm corresponding to the blade, and a main shaft, the device comprising
a base,
a blade arm having a first end and a second end,
a pivot shaft that goes through the base and is connected to the blade arm,
a blade rotation angle driving device, and
a blade braking device,
wherein the blade is connected to the corresponding radial arm through the blade arm of the device; a length axis of the blade is parallel to the main shaft; the first end of the radial arm is connected with the main shaft, and the second end of the radial arm is connected with the device.

2. The device of claim 1, wherein the blade arm is deployed horizontally.

3. The device of claim 1, wherein an intersection point of the blade arm and a mean camber line is set at about ⅓ to ½ from the leading edge and between the leading edge and the tailing edge of the blade.

4. The device of claim 1, wherein the first end of the blade arm is connected with the blade, and the second end of the blade arm is of a fan-shape, acting as a brake disc, and is rotatable around the pivot shaft.

5. The device of claim 4, wherein the blade braking device comprises a caliper that is deployed on the fan-shaped end of the blade arm to brake the blade.

6. The device of claim 4, wherein the brake disc is horizontally or vertically deployed.

7. The device of claim 1, wherein the blade rotation angle driving device is a servo motor that is being connected with a gearbox.

8. The device of claim 1, wherein the blade rotation angle driving device is a hydraulic swing motor.

9. The device of claim 8, further comprising a gear box that is connected to the hydraulic swing motor.

10. The device of claim 1, wherein pivot shaft is vertically deployed and supported by a pair of an upper bearing and a lower bearing, and the lower bearing is an angular contact bearing.

11. The device of claim 1, wherein the leading edge of the blade is balance weighed to make the intersection point of the blade arm and the mean camber line close to or even to meet the center of gravity of the blade.

12. A method for braking a blade of a vertical axis wind turbine, comprising
making a first decision on whether to apply a blade brake based on wind speed input,
making a second decision on whether to conduct feathering when the decision is to apply the blade brake,
conducting the feathering on the blade whether the second decision is that it is necessary for feathering,
braking the blade when the second decision is not to conduct feathering,
controlling blade operation based on wind conditions when the first decision is not to apply the blade brake,
making a third decision on whether over speed regulation is necessary,
making a fourth decision on whether to conduct feathering if the third decision is necessary to have over speed regulation, and
returning to controlling the blade operation based on wind conditions when the third decision is not necessary to have over speed regulation.
